(19) United States
(12) Patent Application Publication
(10) Pub. No.: US 2017/0114710 A1
(43) Pub. Date: Apr. 27, 2017

(54) VARIABLE AIR FIN GEOMETRY IN A CHARGE AIR COOLER

(71) Applicant: GM Global Technology Operations LLC, Detroit, MI (US)

(72) Inventors: Stephen Joseph SANTAVICCA, Sterling Heights, MI (US); Mark R. CLAYWELL, Birmingham, MI (US); Maqsood Rizwan ALI KHAN, Rochester Hills, MI (US)

(21) Appl. No.: 15/209,314

(22) Filed: Jul. 13, 2016

Related U.S. Application Data
(60) Provisional application No. 62/244,327, filed on Oct. 21, 2015.

(51) Int. Cl. F02B 29/04; F28F 13/06; F28D 9/02; F28D 7/06; F28F 3/02; F28F 1/12

(52) U.S. Cl. CPC F02B 29/0462; F28F 3/027; F28F 1/128; F28D 9/02; F28D 7/06; F28F 13/06; F28D 2021/0082

(57) ABSTRACT

A charge air cooler includes a plurality of coolant passages spaced from one another and in communication with an inlet port and an outlet port. A plurality of air cooling fins are disposed between adjacent ones of the plurality of coolant passages, wherein the charge air cooler defines a first region wherein the air cooling fins have a first fin density and a second region wherein the air cooling fins have a second fin density different than the first fin density. The air cooling fins can also be provided with different louver shapes or designs in order to tailor, improve or unify the heat transfer rate at different regions of the charge air cooler.

### CROSS-REFERENCE TO RELATED APPLICATIONS

This application claims the benefit of U.S. Provisional Application No. 62/244,327, filed Oct. 21, 2015. The entire disclosure of the above application is incorporated herein by reference.

### FIELD

The present disclosure relates to a charge air cooler for turbocharged and supercharged engines.

### BACKGROUND

This section provides background information related to the present disclosure which is not necessarily prior art.

Charge air coolers are commonly used for cooling the intake air that exits a compressor of a turbocharged or super charged internal combustion engine. Because of the design of the charge air cooler and the geometry of the intake air channel upstream of the charge air cooler, the heat transfer of the charge air cooler is typically not uniform. It is desirable to provide a charge air cooler with improved heat transfer.

### SUMMARY

This section provides a general summary of the disclosure, and is not a comprehensive disclosure of its full scope or all of its features.

The present disclosure provides a charge air cooler including a plurality of coolant passages spaced from one another and in communication with an inlet port and an outlet port; a plurality of air cooling fins are disposed between adjacent ones of said plurality of coolant passages, wherein the charge air cooler defines a first region wherein the air cooling fins have a first fin density and a second region wherein the air cooling fins have a second fin density different than the first fin density. The air cooling fins can also be provided with different louver shapes or designs in order to tailor or improve the heat transfer rate at different regions of the charge air cooler.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side plan view of an exemplary charge air cooler according to the principles of the present disclosure;

FIG. 2 is a schematic view of the charge air cooler illustrating an aspect of the present disclosure;

FIG. 3 is a schematic view of the charge air cooler illustrating a further aspect of the present disclosure;

FIG. 4 is a schematic view of the charge air cooler illustrating a still further aspect of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

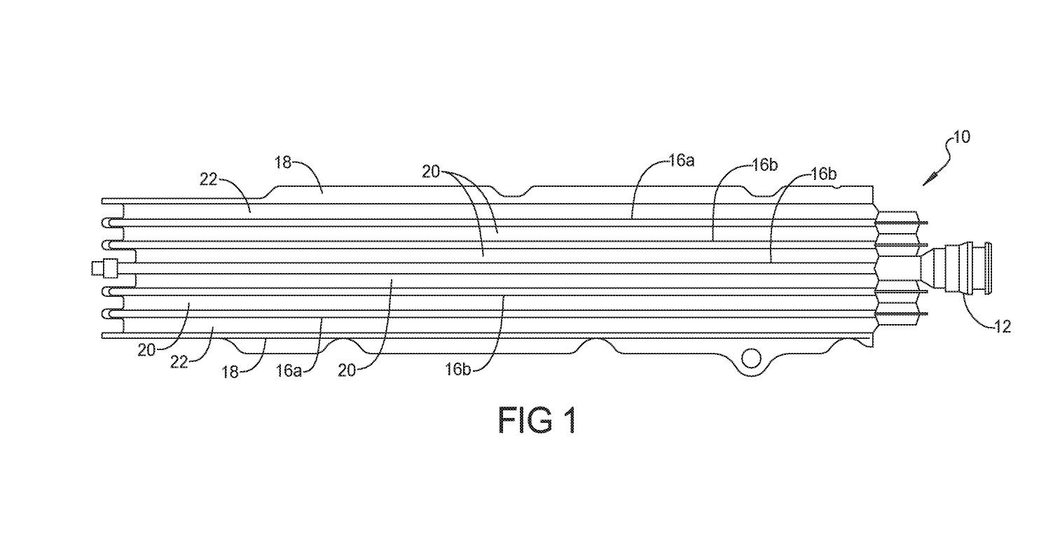

With reference to FIG. 1, an exemplary charge air cooler 10 is shown including an inlet port 12 and an outlet port (not shown because of its location behind the inlet port) each in communication with a plurality of coolant passages 16.

The location of the input and output ports 12 can both be on the same end (as shown in a dual pass cooler system) or on opposite ends of the charge air cooler (in a single pass charge air cooler arrangement). The coolant passages 16 can include at least two most outboard passages 16a disposed on an outer edge of the charge air cooler relative to a plurality of interior coolant passages 16b that are disposed inboard within the charge air cooler relative to the at least two most outboard coolant passages 16a. A pair of outboard plates 18 can be disposed adjacent to the most outboard coolant passages 16a on a side outward relative to the plurality of interior coolant passages 16b.

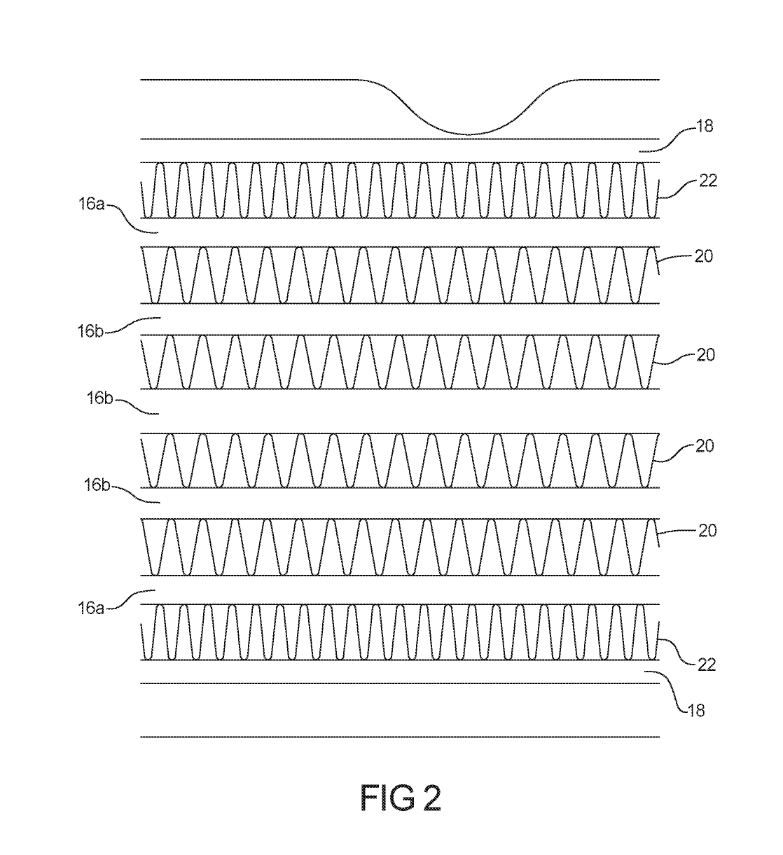

A plurality of interior air cooling fins 20 are disposed between and connected to adjacent ones of the plurality of interior cooling passages. A plurality of outboard air cooling fins 22 are disposed between and connected to the at least two most outboard cooling passages 16a and the pair of outboard plates 18. The interior air cooling fins 20 and the outboard air cooling fins 22 can be formed in various ways. One common method is to form a strip of aluminum or other desired fin material into a series of folds. The folded aluminum strip can then be brazed or soldered to adjacent coolant passages and/or the outboard plates 18. A fin density of the air cooling fins is defined by the number of folds/fins in a unit length. According to one aspect of the present disclosure, as illustrated in FIG. 2, the interior air cooling fins 20 have a first fin density and the outboard air cooling fins 22 have a second fin density that is different than the first fin density of the interior air cooling fins 20. The first fin density of the interior air cooling fins 20 can be greater than the second fin density of the outboard air cooling fins 22. The fin density of the air cooling fins can be readily altered by using a longer or shorter length of folded aluminum strip compressed or stretched into a same length as the other air cooling fin strips when brazing or otherwise attaching them to the cooling channels. Accordingly, no tooling change is required for making the regions of different fin density. The outer air channels through the outboard air cooling fins have less water side cooling since they have only one cooling passage 16 on one side thereof, so a higher fin density in the outboard air cooling fins 22 provides an improved heat transfer. The improved heat transfer from the higher fin density in the outboard air cooling fins 22 is designed to provide an improved heat transfer rate that reduces the charge air temperature.

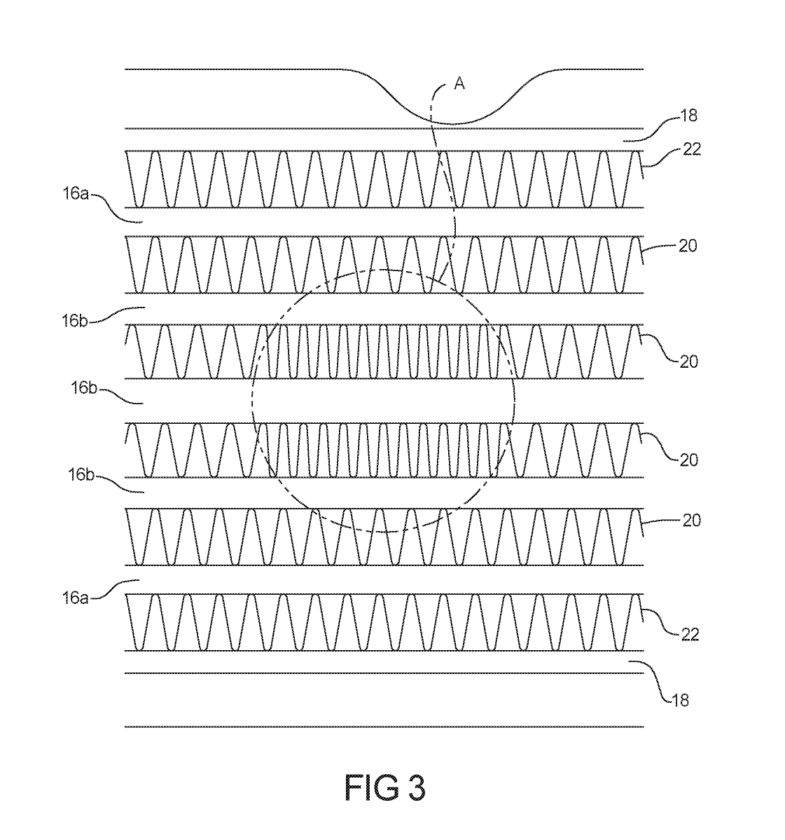

The design of internal combustion engines is largely impacted by the available space under the hood of an aesthetically and aerodynamically designed vehicle. Because of the limited space under the hood, the space upstream of the charge air cooler 10 can also be limited so that there is uneven charge air distribution along a face of the charge air cooler 10. The uneven charge air distribution among other factors can create regions of the charge air cooler 10 that are hotter or cooler than others. By empirical testing and/or analysis, these hotter or cooler regions can be determined and the fin density within those regions can be altered relative to the remaining regions of the charge air cooler. By way of example, as illustrated in FIG. 3, a center region “A” of the charge air cooler is provided with a higher fin density wherein select air cooling fins can be formed from a longer strip of folded aluminum and the desired region “A” can be compressed to a greater density than others. This can be done either in one, multiple or all passages where the fins are provided with a higher local density.

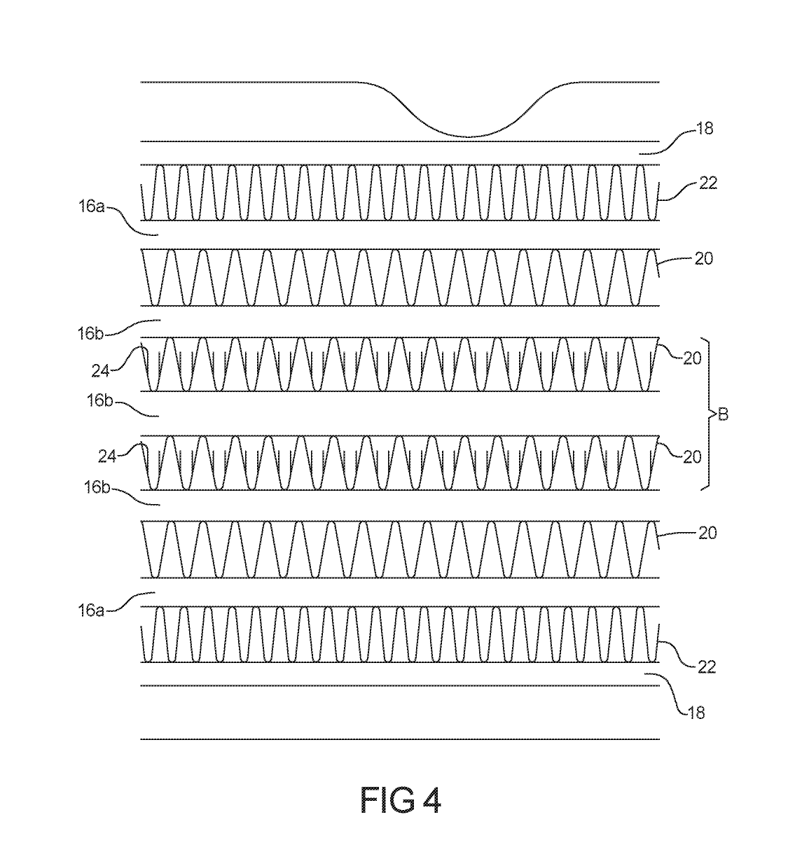

According to a further aspect of the present disclosure, the air cooling fins 20, 22 of a charge air cooler are commonly provided with louvers that are punched through and bent to form a desired shape. The louvers are designed to increase flow turbulence and increase surface area for improving the heat transfer rate. According to the principles of the present disclosure, as shown in FIG. 4, the charge air cooler can be provided with regions “B” provided with air cooling fins 16 having louvers 24 and the remaining regions with no louvers or louvers with a different shape or design. The selective application of louvers of alternative designs or no louvers can provide the charge air cooler with a more uniform heat transfer. It should be understood that the use of alternative fin densities as well as alternative louver designs can be combined to provide a desired heat transfer.

Charge coolers 10 are often very close to the intake ports and it is desirable for all the intake ports to see equal temperatures. Therefore, temperature leaving the different locations of the charge air cooler 10 should be as uniform as possible. Accordingly, it may be desirable to degrade the overall heat exchanger 10 performance to obtain a gain in temperature balance (locally) for the charge air by altering fin densities and adding or removing louvers as disclosed herein. A uniform temperature of charge air leaving the cooler 10, provides a benefit to the engine in terms of knock margin.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A charge air cooler, comprising:
a plurality of coolant passages spaced from one another and in communication with an inlet port and an outlet port, said plurality of coolant passages including two most outboard coolant passages and a plurality of interior coolant passages disposed between the two most outboard passages;
a pair of outboard plates disposed on an outboard side of the two most outboard coolant passages relative to the interior passages;
a plurality of interior air cooling fins each disposed between adjacent ones of said plurality of interior coolant passages and a plurality of outboard air cooling fins each disposed between the most outboard passages and the outboard plates, the interior air cooling fins having a first fin density and the end air cooling fins having a second fin density different than the first fin density.

2. The charge air cooler according to claim 1, wherein the second fin density is higher than the first fin density.

3. A charge air cooler, comprising:
a plurality of coolant passages spaced from one another and in communication with an inlet port and an outlet port;
a plurality of air cooling fins each disposed between adjacent ones of said plurality of coolant passages, wherein the charge air cooler defines a first region wherein the air cooling fins have a first fin density and a second region wherein the air cooling fins have a second fin density different than the first fin density.

4. The charge air cooler according to claim 3, wherein the second fin density is higher than the first fin density.

5. A charge air cooler, comprising:
a plurality of coolant passages spaced from one another and in communication with an inlet port and an outlet port;
a plurality of air cooling fins each disposed between adjacent ones of said plurality of coolant passages, wherein the charge air cooler defines a first region wherein the air cooling fins have a first louver design and a second region wherein the air cooling fins have a second louver design or a lack of louvers that differ from the first louver design.
